(19) United States
(12) Patent Application Publication
(10) Pub. No.: US 2026/0290050 A1
(43) Pub. Date: Sep. 24, 2026

(54) NON-UNIFORM ILLUMINATION CORRECTION FOR PCR

(71) Applicant: Life Technologies Corporation, Carlsbad, CA (US)

(72) Inventors: Deepankar Chanda, San Francisco, CA (US); Christopher Brandon Thomas, San Mateo, CA (US); Noah Graham Schissell Elder, Lafayette, CA (US)

(21) Appl. No.: 19/476,000

(22) PCT Filed: Apr. 17, 2024
(86) PCT No.: PCT/US2024/025022

§ 371 Date: Oct. 16, 2025

Related U.S. Application Data
(60) Provisional application No. 63/460,884, filed on Apr. 20, 2023.

(51) Int. Cl. G06V 20/69; G06V 10/98

(52) U.S. Cl. CPC G06V 20/69; G06V 10/98

(57) ABSTRACT

Disclosed embodiments include a digital Polymerase chain reaction (dPCR) operative system having a method of digital image processing that corrects for illumination bias in data relating to an array of a sample plate comprising one or more arrays of sample partitions. In some embodiments, the method includes obtaining background image data corresponding to a digital image captured by the camera of the dPCR system after a background cycle of a dPCR assay. With respect to each partition, a local flat-fielding coefficient is derived and applied to the background image data to obtain local-bias-corrected background image data. Next, the local bias-corrected background data is used to determine a set of global flat-fielding coefficients. The local and global flat-fielding coefficients are subsequently used to correct illumination bias endpoint image data to generate endpoint bias-corrected illumination values.

### CROSS-REFERENCE TO RELATED APPLICATIONS

This application claims the benefit of U.S. Provisional Application No. 63/460,884 filed Apr. 20, 2023. This application also has some subject matter relationship to commonly assigned Provisional Application Nos. U.S. 63/460,882, U.S. 63/460,885, U.S. 63/460,879, all filed on Apr. 20, 2023. The contents of these applications are incorporated herein by reference in their entirety.

### BACKGROUND

This disclosure relates generally to image processing systems for processing Polymerase Chain Reaction (PCR) data for samples distributed across an array of microchambers of a microplate and, more particularly, to a PCR system and method for correcting non-uniformity associated with illumination bias.

PCR can be performed on biological samples that contain or are suspected to contain a target analyte of interest, such as a cell, tissue, or specimen such as hair, a biological fluid such as blood, urine, saliva, etc., a cell cluster such as a microbial colony, or an organism, cell, microbe, bacterium, virus, protein, antibody, or nucleic acids such as such as DNA or RNA molecules. Target analytes include “original” analytes that were originally present in the biological sample as well any “synthetic” analytes that are indicative of the presence of original analytes which may be added or generated during detection, including PCR amplicons, antigen-antibody complexes, etc. Determining whether a target analyte is present in a sample, and in what quantity, is accomplished by measuring the fluorescence of samples using images taken before, during, and/or after thermal cycles of the PCR instrument. PCR includes both quantitative PCR (qPCR) (sometimes referred to as real time PCR) and digital PCR (dPCR). In qPCR, sample fluorescence is typically obtained and analyzed for most or all cycles of the PCR assay, and the collection of such values for a given sample are known as an “amplification curve” for that sample. In dPCR, each sample is partitioned into very small quantities and, typically, an array of such partitions is imaged at an endpoint cycle and binary present/absent terminations are made for each partition of the sample based on the endpoint fluorescence values.

More specifically, dPCR typically involves partitioning a PCR solution that includes the sample into tens of thousands of nano-liter sized droplets, where a separate PCR reaction takes place in each one. The PCR solution may include, for example, template DNA (or RNA), fluorescence-quencher probes, primers, and a PCR master mix, which contains DNA polymerase, dNTPs, MgCl₂, and reaction buffers at optimal concentrations. Several different methods can be used to partition samples, including microchambers, microwell plates, capillaries, oil emulsion, and arrays of miniaturized chambers with nucleic acid binding surfaces. This partitioning of samples allows a more reliable collection and sensitive measurement of nucleic acid amounts. The method has been demonstrated as useful for studying variations in gene sequences, such as copy number variants and point mutations, and it is routinely used for clonal amplification of samples for next-generation sequencing.

Typically, dPCR instrumentation includes a microplate having a large number of partitions (e.g., over 1,000, over 20,000, over 100,000, etc.). A fluorescent dye functions as an intercalating agent that emits detectable fluorescence when bound to DNA (e.g., human DNA or DNA of an infectious agent). As the PCR progresses and the quantity of DNA increases, more dye binds to the PCR products and hence, signal intensity increases.

### SUMMARY

An image taken by the camera of a PCR instrument may possess an illumination bias. Illumination bias is a spatial phenomenon, which is observed as a non-uniform variation of the detected intensity of the fluorescent reactions across the image. Assuming a perfect master-mix within the microfluidic array plate having uniform fluorescence, the variation in illumination can be a consequence of the instrumentation, including variations in the illumination source, placement of the source, the composition and geometry of the sample plate, distortion in light due to optical, lens effects, and the like.

Flat-fielding is an image processing method used to correct illumination bias. One approach to flat-fielding involves estimating illumination non-uniformity on a buffer/blank plate. This involves computation of flat-fielding coefficients for each filter channel. These coefficients can be approximated using a smooth low-frequency background signal by low-pass filtering the buffer plate image. Other methods involve imaging a plate during dye calibration and follow the same steps of the prior method to compute the coefficients in each channel. The computed coefficients can then be applied to all runs on that instrument provided that the illumination source or other factors impacting illumination uniformity does not vary significantly over time.

Unfortunately, existing approaches to correcting illumination bias for PCR systems suffer from several issues. They assume optical response in an instrument is static over time. Any change in optical characteristics, for example due to LED degradation, material degradation, or overtime wear of instrument, can cause large variations in the optical signal, which can necessitate re-calibration of the estimated coefficients. Incorrect flat-fielding coefficients lead to over or under-correction of the optical bias after a period of time has elapsed from the calibration of the instrument. These standard approaches also assume spatial response is regular and fixed. However, most PCR instruments possess moving components (including the camera). Hence, the measured luminosity in a specified position varies from one run to another. In addition, the optical response is also affected by the geometry of the consumable plate. Different “units” on the plate exhibit a differing spatial response. During estimation of the flat-fielding coefficients, these standard approaches allocate a non-trivial weight to contributions of pixels not belonging to the true signal source, which should be the microchamber or sample partition. Accordingly, the signal-to-noise ratio post-flat-fielding is reduced. Further, these standard approaches operate over the entire image, which makes these approaches computationally inefficient. Moreover, there might be local spatial variations in illumination bias that follow a different pattern within a larger more global pattern.

Embodiments of a PCR system and method for improved non-uniform illumination correction are disclosed herein. In some embodiments, the PCR system computes the flat-fielding coefficients in an online fashion for each run. That is, the coefficients are estimated for every new run on the instrument and rather than relying on previously computed values determined during instrument calibration. Further, in some embodiments, the PCR system computes the flat-fielding coefficients for each partition (for example, each microchamber) in each array of partitions on the plate. In some embodiments, the PCR system computes the flat-fielding coefficients using data obtained from only the pixels associated with partitions, rather than from all pixels in the image. By estimating the coefficients on only a small subset of the overall image data, this PCR system significantly reduces the computation time for illumination bias correction. It should be appreciated that the present embodiments can be implemented in numerous ways, such as a process, an apparatus, a system, a device, or a method. Several embodiments of the present disclosure are described below.

In some embodiments, background image data comprising background illumination values derived from a digital image captured at a background cycle of a PCR assay run is retrieved. In some embodiments, a processor-based illumination correction engine derives a set of local flat-fielding coefficients, wherein each local flat-fielding coefficient is derived using two or more of the background illumination values. The set of local flat-fielding coefficients are applied to the background illumination values to obtain local-bias corrected background illumination values.

Next, a set of global flat-fielding coefficients are derived using the local-bias corrected illumination values. Both sets of the local and global flat-fielding coefficients are applied to the endpoint image data to generate endpoint illumination data that has been corrected for local and global illumination bias.

In one embodiment, local flat-fielding coefficients are obtained by defining a plurality of local spatial units and using the local spatial units to select local illumination values for computing local flat-fielding coefficients associated with sample partitions in an array of sample partitions. In some embodiments, each local spatial unit includes two or more sample partitions. The set of local spatial units are associated with an observed local illumination bias pattern that exhibits varied illumination in a repeating pattern from one local spatial unit to another. The local spatial units can be sorted into at least two categories (a first spatial category and a second spatial category) corresponding to different levels of illumination resulting from the local illumination bias pattern. In one example, the first spatial category is even-numbered rows (m-rows) and the second spatial category is odd-numbered rows (n-rows).

Other aspects of the embodiments will become apparent from the following detailed description taken in conjunction with the accompanying drawings which illustrate, by way of example, the principles of the described embodiments.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates a networked PCR system having an illumination bias correction (flat-fielding) engine with improved performance in accordance with an embodiment of the present disclosure.

FIG. 2 is a block diagram of the bias correction (flat fielding) engine of the server of FIG. 1, in accordance with some embodiments.

FIG. 3A is a flow diagram of a method for an illumination bias correction of PCR operative system of FIG. 1, in accordance with some embodiments.

FIG. 3B is a flow diagram of a method for verifying one or more background cycle conditions of the illumination bias correction method of FIG. 3A, in accordance with some embodiments.

FIG. 3C is a flow diagram of a method for deriving local flat-field coefficients of the illumination bias correction method of FIG. 3A, in accordance with some embodiments.

FIG. 3D is a flow diagram of a method for deriving global flat-field coefficients of the illumination bias correction method of FIG. 3A, in accordance with some embodiments.

FIG. 3E is a flow diagram of a method for applying local illumination bias correction of the illumination bias correction method of FIG. 3A, in accordance with some embodiments.

FIG. 3F is a flow diagram of a method for applying global illumination bias correction of the illumination bias correction method of FIG. 3A, in accordance with some embodiments.

FIG. 4 displays an illustration showing an example of a computing device which may implement the examples described herein.

### DETAILED DESCRIPTION

The various embodiments now will be described more fully hereinafter with reference to the accompanying drawings, which form a part hereof, and which show, by way of illustration, specific examples of practicing the embodiments. This specification may, however, be embodied in many different forms and should not be construed as limited to the embodiments set forth herein; rather, these embodiments are provided so that this specification will be thorough and complete, and will fully convey the scope of the invention to those skilled in the art. Among other things, this specification may be embodied as methods or devices.

Accordingly, any of the various embodiments herein may take the form of an entirely hardware embodiment, an entirely software embodiment or an embodiment combining software and hardware aspects. The following specification is, therefore, not to be taken in a limiting sense.

In some embodiments, the PCR operative system and method of processing datasets associated with biological sampling distributed across an array of microchambers of a microplate includes a processor-based illumination bias correction engine, having non-uniform illumination bias correction. Particularly, this PCR operative system having improved illumination bias correction performance and accuracy is comprised of PCR processing module including a bias correction flat-fielding engine which combines local and global illumination bias correction. The method of digital image processing that corrects for illumination bias in data generated from a PCR assay is conducted on an array of a sample plate comprising at least one array of sample partitions.

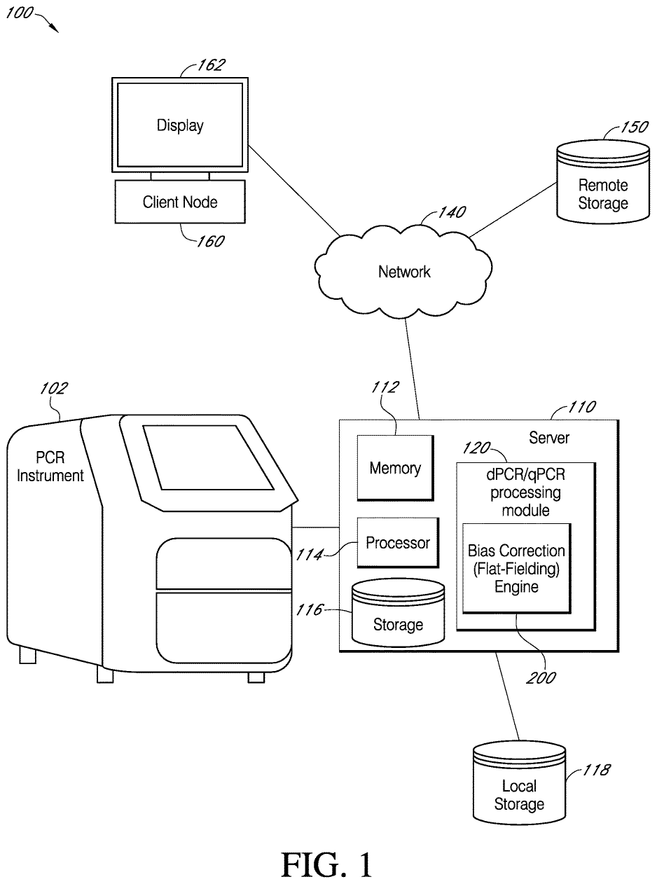

FIG. 1A illustrates networked digital Polymerase Chain Reaction (“dPCR”) system 100 having a bias correction (flat-fielding) engine 200 for performing the method of illumination bias correction (flat-fielding) in accordance with an embodiment of the present disclosure. System 100 comprises dPCR Instrument 102, at least one client node 160, and server 110. Digital PCR instrument 102 includes microplate (not shown) having an array of microchambers filled with a biological sample. Instructions for implementing dPCR reside in a bias correction (flat fielding) engine 200 (a computer program product) within dPCR processing module 120 which is stored in storage 116 and those instructions are executable by processor 114. When processor 114 is executing the instructions of dPCR processing module 120, the instructions, or a portion thereof, are typically loaded into working memory 112 from which the instructions are readily accessed by processor 114. In the illustrated embodiment, bias correction (flat fielding) engine 200 is stored in local storage device 116 or another non-transitory computer readable medium (which may include being distributed across media on different devices and different locations).

Although not shown, dPCR instrument 102 includes a microplate (not shown) having the plurality of partitions including a fluorescent dye solution. The dye functions as an intercalating agent that emits detectable fluorescence when bound to double-stranded DNA or infectious agent. As the PCR progresses and the quantity of double-stranded DNA increases, more dye binds to the PCR products and hence, signal intensity increases. Digital PCR instrument 102 also includes a thermal cycler (not shown) for amplification, and a light source (not shown) for excitation of fluorescent probes associated with the plurality of partitions. A camera (not shown) couples to record the fluorescent reactions of the plurality of partitions and deliver the image to dPCR processing module 120 enabled to control the instrument, detect fluorescent datasets, and perform illumination bias correction.

Specifically, after multiple PCR amplification cycles, the samples are checked for fluorescence, where dPCR processing module 120 detects a binary readout of “0” or “1” associated with the array of microchambers.

In one embodiment, processor 114 comprises multiple processors, which may comprise additional working memories (additional processors and memories not individually illustrated) including a graphics processing unit (GPU) comprising at least thousands of arithmetic logic units supporting parallel computations on a large scale. GPUs are often utilized in deep learning applications because they can perform the relevant processing tasks more efficiently than typical general-purpose processors (CPUs). Other embodiments comprise one or more specialized processing units comprising systolic arrays and/or other hardware arrangements that support efficient parallel processing. In some embodiments, such specialized hardware works in conjunction with a CPU and/or GPU to carry out the various processing described herein. In some embodiments, such specialized hardware comprises application specific integrated circuits and the like (which may refer to a portion of an integrated circuit that is application-specific), field programmable gate arrays and the like, or combinations thereof. In some embodiments, however, a processor such as processor 114 may be implemented as one or more general purpose processors (preferably having multiple cores) without necessarily departing from the spirit and scope of the present invention.

Client node 160 includes display 162 for displaying results of processing carried out by dPCR processing module 120. In alternative embodiments, bias correction (flat fielding) engine 200, or a portion thereof, may be stored in storage devices and executed by one or more processors residing on PCR instrument 102 and/or client node 160. Such alternatives do not depart from the scope of the invention.

In some embodiments, system 100 includes a network 140 coupled between the server 110 and client node 160. Although not shown in some embodiments, server 110 and client node 160 couple directly to one another without network 140. The system may also include at least one dumb terminal (not shown), such as a land line, cell phone, pager monitor, and the like. Although not shown, server 110 may also be coupled to a conventional telephone (not shown) by Public Switched Telephone Network (PSTN), which couples to the network 110. The server 110 may couple to the remote storage device 150 for reference to prior PCR analysis results and versions of other parameters described below. In some embodiments, each client node 160 includes dPCR/qPCR agent 104, data analysis system 102, memory (not shown), a processor (not shown), and local data store (not shown).

In some embodiments, server 110, having dPCR processing module 120 and bias correction (flat fielding) engine 200, communicates with each client node 160 and serves as the sole agent that performs the method of PCR described herein. In other embodiments, a copy of the bias correction (flat fielding) engine (not shown) within client node 160 serves as a device that communicates with the server 110 to perform the method of illumination bias correction (flat fielding) in real-time described more in detail below. The one or more client nodes 160, server 110, and the remote storage device 150 may reside on the same LAN, or on different LANs that may be coupled together through the Internet, but separated by firewalls, routers, and/or other network devices. In one embodiment, one or more client nodes 160 couple to network 110 through a mobile communication network. In another embodiment, one or more client nodes 160, server 110, and the remote storage device 150 reside on different networks. In some embodiments, server 110 resides in a cloud network. Although not shown, in various embodiments, one or more client nodes 160 may be notebook computers, desktop computers, microprocessor-based or programmable consumer electronics, network appliances, mobile telephones, smart telephones, pagers, radio frequency (RF) devices, infrared (IR) devices, Personal Digital Assistants (PDAs), set-top boxes, cameras, integrated devices combining at least two of the preceding devices, and the like. FIG. 1A illustrates that dPCR processing module 120 may also entirely or partially operate PCR instrument 102. The one or more client nodes 160 may include a PDA, a Global Positioning System (GPS) device, a monitor, an interactive television, and Internet protocol (IP) phone, a pager, a cellular phone, a satellite phone, and the like.

In some embodiments, the one or more client nodes 160 comprise a processor (not shown), memory (not shown), and a copy of a bias correction (flat fielding) engine 200 in computer-readable storage (not shown). In some embodiments, the one or more client nodes 160 may comprise processing software instructions and/or hardware logic required for PCR illumination bias correction analysis according to the embodiments described herein.

In some examples, server 110 provides remote cloud storage capabilities for PCR analysis and various types of PCR policies associated, through the remote storage device 150 coupled by network 140. Additionally, server 110 provides remote storage capabilities for PCR analysis data. In some embodiments, server 110 retrieves previous results relating to PCR analysis data and policies relating to the same from a remote datastore 150 to a local data store 118. In other embodiments, the database of PCR illumination bias correction policies, prior detection results, and the like may be stored locally on the one or more client nodes 160, local storage 116, or the server 110. In particular, for remote storage purposes, the local data storage unit 118 can be one or more centralized data repositories having mappings of respective associations between each fragment data and its location within remote storage devices 150. Local data store 116 may represent a single or multiple data structures (databases, repositories, files, etc.) residing on one or more mass storage devices, such as magnetic or optical storage-based disks, tapes or hard drives. This local data store 116 may be an internal component of server 110. In the alternative, the local data store 118 couples externally to server 110, or remotely through a second network (not shown). Further, server 110 may communicate with remote storage devices over a public or private network. Although not shown, in various embodiments, the server 110 may be a notebook computer, desktop computer, microprocessor-based or programmable consumer electronics, network appliance, mobile telephone, smart telephone, radio frequency (RF) device, infrared (IR) device, Personal Digital Assistant (PDA), set-top box, an integrated device combining at least two of the preceding devices, and the like.

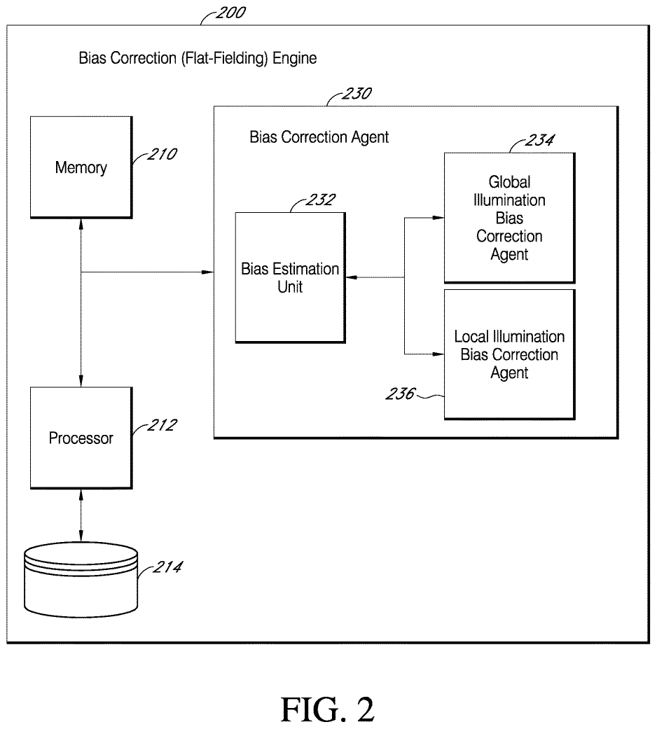

FIG. 2 is a block diagram of the bias correction (flat fielding) engine 200 of the server of FIG. 1, in accordance with some embodiments. Bias correction (flat fielding) engine 200 comprises a bias correction agent 230, memory 210, processor 212, and storage device 214. Bias correction agent 230 includes a bias estimation unit 232, a global illumination bias correction agent 234, and a local illumination bias correction agent engine 236. In operation, bias correction agent 230 in cooperation with processor 212 couples to memory 210 and storage device 214 to retrieve and process illumination bias correction instructions. These illumination bias correction instructions can be stored in local storage devices (116, 117) and or remote storage device 150 (FIG. 1). Bias estimation unit 232 couples to receive background image data corresponding to a digital image captured using a camera (not shown) corresponding to a plurality of optical signals detected at dPCR instrument 102 (FIG. 1), wherein the background image data includes a plurality of background illumination values corresponding to each sample partition associated with an array of the at least one array of sample partitions. Bias estimation unit 232 couples to both global illumination bias correction agent 234 and local illumination bias correction agent engine 236 to derives a set of local and global flat-fielding coefficients for generating a corrected illumination-bias image associated with the endpoint image data.

In operation, a user of the dPCR system 100, having improved illumination bias correction performance and accuracy, opens a front panel to insert the microplate (not shown) within the dPCR instrument 102 (referring to FIGS. 1 and 2). Prior to placement, the user fills the array of microchambers of the microplate with a biological sample for dPCR analysis. Bias estimation unit 232 directs the at least one memory 210 of bias correction (flat fielding) engine 200 (having computer-readable instructions stored thereon that, when executed by the at least one processor 114) to enable bias estimation unit 232 to receive, from dPCR instrument 102, background image data corresponding to a plurality of background illumination values corresponding to each sample partition associated with an array of the at least one array of sample partitions. Local illumination bias correction agent engine 236 couples to the bias estimation unit 232 and the at least one memory 210 having instructions that cause the at least one processor 212 to determine a set of local flat-fielding coefficients, wherein a local flat-fielding coefficient is calculated for each sample partition of the array. In particular, the set of local flat-fielding coefficients is associated with an observed local illumination bias pattern that exhibits varied illumination in a repeating pattern from one local spatial unit to another. Local illumination bias correction agent engine 236 sorts the plurality of local spatial units into at least two categories, a first spatial category and a second spatial category, corresponding to different levels of illumination resulting from the local illumination bias pattern. Global illumination bias correction agent 234 determines a set global flat-fielding coefficients based upon the set of local flat-fielding coefficients, wherein a global flat-fielding coefficient is calculated for each sample partition of the array. Both the local and global illumination bias correction agents (234, 236) send these sets of local and global flat-fielding coefficients to bias estimation unit 232, where the illumination-bias-corrected image is derived. In particular, bias estimation unit 232 retrieves endpoint image data corresponding to a digital image captured after an endpoint cycle of the run of the PCR assay. The endpoint image data includes a plurality of endpoint illumination values corresponding to each sample partition associated with the array. Bias estimation unit 232 applies the set of local flat-fielding coefficients and the set of global flat-fielding coefficients to the plurality of endpoint illumination values to obtain a plurality of illumination-bias-corrected endpoint illumination values.

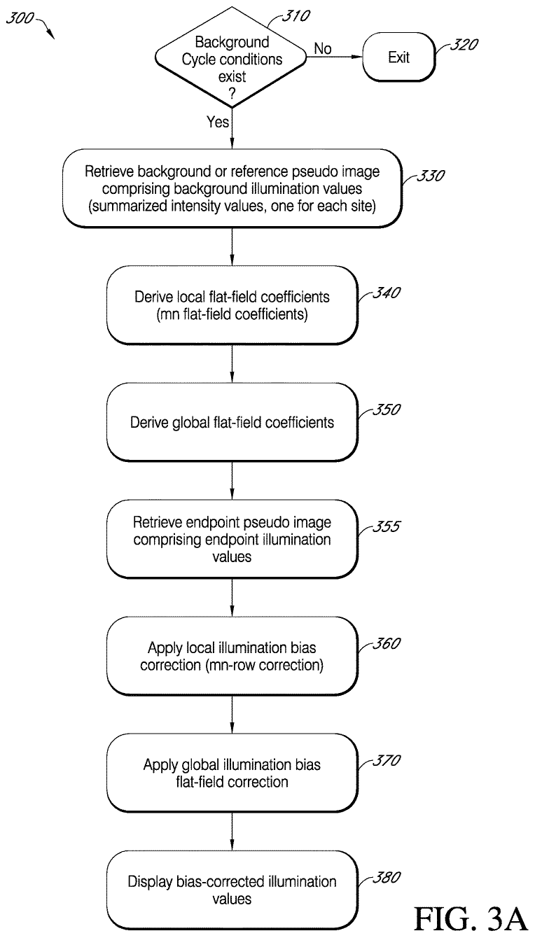

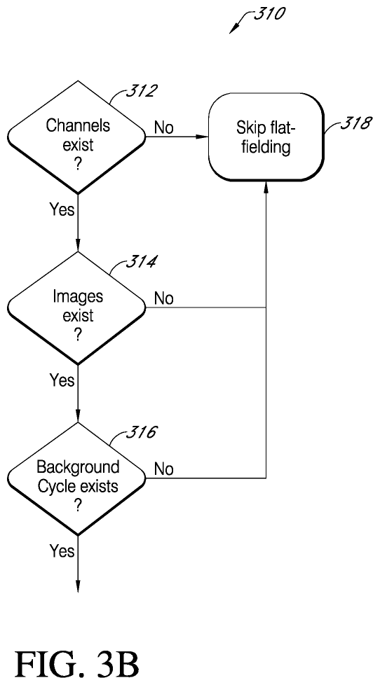

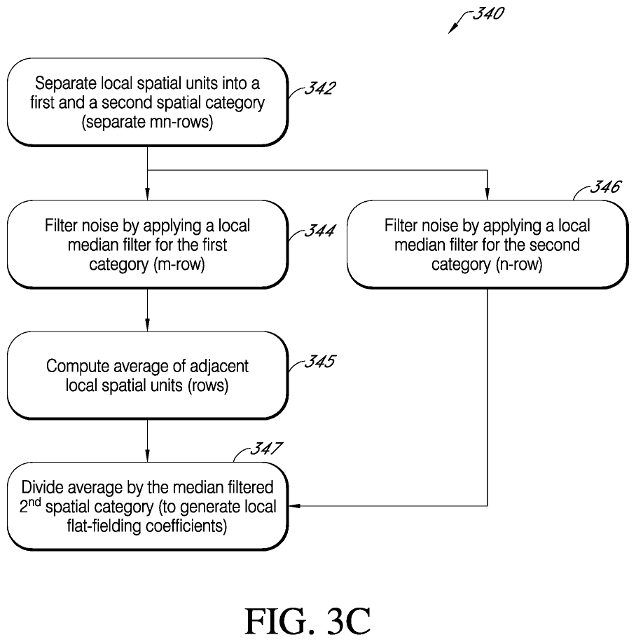

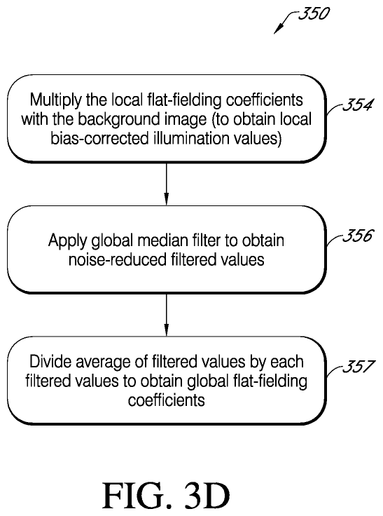

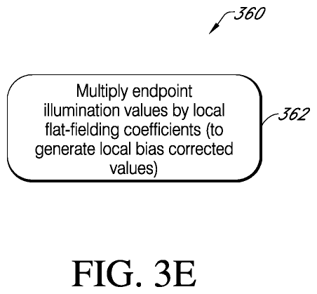

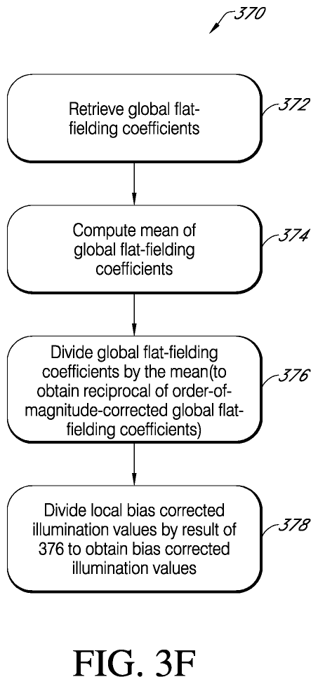

FIG. 3A is a flow diagram of method 300 for an illumination bias correction of PCR operative system of FIG. 1, in accordance with some embodiments. In some embodiments, method 300 of illumination bias correction begins with verifying one or more background cycle conditions in a decision action 310. If the background cycle conditions cannot be confirmed, flat-fielding illumination bias correction in accordance with the system and method described herein is ended. In an action 330, method 300 includes receiving the background or reference pseudo image comprising background illumination values (summarized intensity values, one for each site) corresponding to a plurality of background illumination values corresponding to each sample partition associated with an array of the at least one array of sample partitions. For example, bias estimation unit 232 directs the at least one memory 210 of bias correction (flat fielding) engine 200 (having computer-readable instructions stored thereon that, when executed by the at least one processor 114) to enable bias estimation unit 232 to receive, from dPCR instrument 102, background image data corresponding to a plurality of background illumination values corresponding to each sample partition associated with the array of the at least one array of sample partitions. In an action 340, method 300 derives a set of local flat-fielding coefficients. For example, local illumination bias correction agent engine 236 couples to the bias estimation unit 232 and the at least one memory 210 having instructions that cause the at least one processor 212 to determine a set of local flat-fielding coefficients, wherein a local flat-fielding coefficient is calculated for each sample partition of the array. In an action 350, method 300 derives the set of global local flat-fielding coefficients. Global illumination bias correction agent 234 determines a set global flat-fielding coefficients based upon the set of local flat-fielding coefficients, wherein a global flat-fielding coefficient is calculated for each sample partition of the array. In an action 355, method 300 retrieves the end-point pseudo image comprising endpoint illumination values. For example, after a PCR amplification cycle number designated to be the endpoint cycle, the sample partitions are checked for fluorescence, and, based on comparison to a threshold level, a fluorescence value for a given sample partition is considered to represent presence (amplification) or absence (no amplification) of a target analyte. In an action 360, method 300 includes applying local illumination bias correction. For example, bias estimation unit 232 retrieves endpoint image data corresponding to a digital image captured after an endpoint cycle of the run of the PCR assay. The endpoint image data includes a plurality of endpoint illumination values corresponding to each sample partition associated with the array. Bias estimation unit 232 applies the set of local flat-fielding coefficients to derive a local bias corrected image. In an action 370, method 300 applies global illumination bias correction. For example, bias estimation unit 232 applies the set of global flat-fielding coefficients to derive a global bias corrected image. Both the local and global illumination bias correction agents (234, 236) send these sets of local and global flat-fielding coefficients to bias estimation unit 232, where the illumination-bias-corrected image is derived. Bias estimation unit 232 applies the set of local flat-fielding coefficients and the set of global flat-fielding coefficients to the plurality of endpoint illumination values to obtain a plurality of illumination-bias-corrected endpoint illumination values. In an action 380, method 300 displays bias-corrected illumination values on a user interface of display 162 (FIG. 1).

Referring now to FIG. 3B, a flow diagram of method 310 for verifying one or more background cycle conditions of the illumination bias correction method of FIG. 3A is shown to include three decision actions (312, 314, and 316). In a decision action 312, the PCR processing module 120 verifies whether channels exist. In response to verification of channels, method 310 includes verifying the existence of images exist in action 314. In response to verification of images, method 310 includes verifying if the background cycle exists in action 316. If the channels, images, or background cycle cannot be detected, flat-fielding based upon the method of illumination bias correction disclosed herein is not performed (as shown in actions 318 and 320).

Referring now to FIG. 3C, method 340 for deriving local flat-field coefficients of the illumination bias correction method of FIG. 3A includes separating the one or more plurality of local spatial units in an action 342. In one example, the local spatial units are rows, where the plurality of local spatial units are divided into two categories. In an example, a first spatial category is one or more even (m rows) and a second spatial category is one or more odd (n rows). In an action 344, noise is filtered from the signal by applying a local median filter on each one of the plurality of local spatial units associated with the first spatial category (even row). In an action 346, noise is filtered from the signal by applying a local median filter on each one of the plurality of local spatial units associated with the second spatial category (odd row). Method 340 also includes computing an average of adjacent local spatial units in the filtered plurality of local spatial units associated with the first spatial category in an action 345. The average is divided by the filtered plurality of local spatial units associated with the second spatial category to generate the set of local flat-fielding coefficients in an action 347.

Referring now to FIG. 3D, method 350 for deriving global flat-field coefficients of the illumination bias correction method of FIG. 3A includes multiplying the local flat-fielding coefficients with the background image to obtain local-bias-corrected illumination values, in an action 354. Global illumination bias correction agent 234 determines a set global flat-fielding, wherein a global flat-fielding coefficient is calculated for each sample partition of the array. Global illumination bias correction agent 234 retrieves the local flat-fielding coefficients and multiplies the background image values by the local flat-fielding coefficients. In an action 356, method 350 applies global median filter to obtain noise-reduced/filtered values. Further, method 350 divides the average of filtered values by each filtered value to obtain the global flat-fielding coefficients in an action 357.

Referring now to FIG. 3E, method 360 for applying local illumination bias correction of the illumination bias correction method of FIG. 3A includes step 362 of multiplying the endpoint illumination values by the local flat-fielding coefficients to generate local bias corrected values to be applied when generating the bias illumination corrected image. For example, bias estimation unit 232 retrieves endpoint image data corresponding to a digital image captured after an endpoint cycle of the run of the PCR assay and multiplies the endpoint image data to the set of local flat-fielding coefficients.

Referring now to FIG. 3F, method 370 for applying global illumination bias correction of the illumination bias correction method of FIG. 3A includes a first step of retrieving the set of global flat-fielding coefficients in an action 372. For example, global illumination bias correction agent 234 sends these set of global flat-fielding coefficients to bias estimation unit 232. In the alternative, the bias estimation unit 232 can request the set of global flat-fielding coefficients from the global illumination bias correction agent 234. In an action 374, the mean of the set of global flat-fielding coefficients is generated. For example, bias estimation unit 232 determines the mean of the set of global flat-fielding coefficients. In an action 376, method 370 divides the set of global flat-fielding coefficients by the mean to obtain reciprocal of order-of-magnitude-corrected global flat-fielding coefficients. For example, bias estimation unit 232 computes the division of the set of global flat-fielding coefficients by the mean to generate global bias corrected values. Further, method 370 divides the local bias corrected illumination values by the reciprocal of order-of-magnitude-corrected global flat-fielding coefficients to obtain an bias-corrected illumination values in an action 378. For example, bias estimation unit 232 divides the local bias corrected values by the global bias corrected values to generate the illumination bias corrected image, which can be displayed for further observation and analysis purposes.

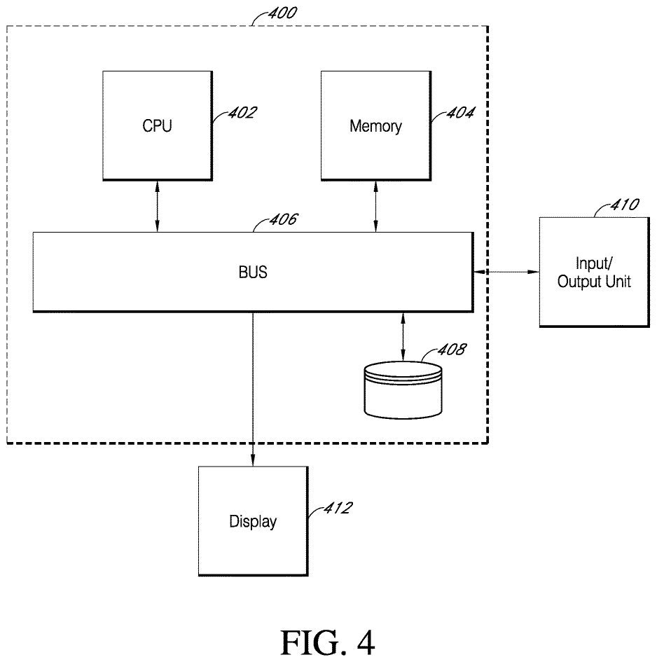

Referring now to FIG. 4, an illustration showing an example of a computing device which may implement the examples described herein is displayed. In the example, computer system 400 may provide one or more of the components of an dPCR/analysis configured to implement one or more logic modules and artificial neural networks and associated components for a computer-implemented dPCR analysis and associated interactive graphical user interface. It should be appreciated that the methods described herein may be performed with a digital processing system, such as a conventional, general-purpose computer system. Special purpose computers, which are designed or programmed to perform only one function may be used in the alternative. The computing device of FIG. 4 may be used to perform embodiments of the functionality for performing dPCR analysis and illumination bias correction in accordance with some embodiments. The computing device includes a central processing unit (CPU) 402, which is coupled through a bus 406 to a memory 404, and mass storage device 408. Mass storage device 408 represents a persistent data storage device such as a floppy disc drive or a fixed disc drive, which may be local or remote in some embodiments. The mass storage device 408 could implement backup storage, in some embodiments. Memory 404 may include read only memory, random access memory, etc. Applications resident on the computing device may be stored on or accessed through a computer readable medium such as memory 404 or mass storage device 408 in some embodiments. Applications may also be in the form of modulated electronic signals modulated accessed through a network modem or other network interface of the computing device. It should be appreciated that CPU 402 may be embodied in a general-purpose processor, a special purpose processor, or a specially programmed logic device in some embodiments.

Display 412 is in communication with CPU 402, memory 404, and mass storage device 408, through bus 406. Display 412 is configured to display any visualization tools or reports associated with the system described herein.

Input/output device 410 is coupled to bus 406 in order to communicate information in command selections to CPU 402. It should be appreciated that data to and from external devices may be communicated through the input/output device 410. CPU 402 can be defined to execute the functionality described herein to enable the functionality described with reference to FIGS. 1-3F. The code embodying this functionality may be stored within memory 404 or mass storage device 408 for execution by a processor such as CPU 402 in some embodiments. The operating system on the computing device may be iOS™, MS-WINDOWS™, OS/2™, UNIX™, LINUX™, or other known operating systems. It should be appreciated that the embodiments described herein may be integrated with virtualized computing system also.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, flash memory devices, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In the context of the specification, at least the following embodiments are described. Embodiment 1 is a method of digital image processing that corrects for illumination bias in data generated from a polymerase chain reaction (PCR) assay conducted on a sample using a PCR instrument and a sample plate, the sample plate comprising at least one array of sample partitions, the method including using one or more computer processors to execute processing comprising retrieving background image data corresponding to a background image captured after a background cycle of a run of the PCR assay by a bias correction flat-fielding engine, the background image data including a plurality of background illumination values corresponding to each sample partition associated with an array of the at least one array of sample partitions; determining, using the background image data and an observed local bias illumination pattern, a set of local flat-fielding coefficients, wherein a local flat-fielding coefficient is calculated for each sample partition of the array; determining a set global flat-fielding coefficients, wherein a global flat-fielding coefficient is calculated for each sample partition of the array; retrieving endpoint image data corresponding to an endpoint image captured after an endpoint cycle of the run of the PCR assay, the endpoint image data including a plurality of endpoint illumination values corresponding to each sample partition associated with the array; and applying the set of local flat-fielding coefficients and the set of global flat-fielding coefficients to the plurality of endpoint illumination values to obtain a plurality of illumination-bias-corrected endpoint illumination values.

Embodiment 2 is the method of embodiment 1 wherein each background illumination value of the plurality of background illumination values comprises a site summary value summarizing pixel intensity values of pixels of a corresponding one sample partition in the background image; and each endpoint illumination value of the plurality of endpoint illumination values comprises a site summary value summarizing pixel intensity values of pixels of a corresponding one sample partition in the endpoint image. Embodiment 3 is the method according to embodiments 1 or 2 wherein the observed local illumination bias pattern is associated with a plurality of local spatial units exhibiting varied illumination in a repeating pattern from one local spatial unit to another local spatial unit, such that the plurality of local spatial units can be sorted into at least two categories, a first spatial category and a second spatial category, corresponding to different levels of illumination resulting from the local illumination bias pattern. Embodiment 4 is the method of embodiment 3, wherein the plurality of local spatial units is a plurality of rows, and wherein the first spatial category comprises one or more m rows and the second spatial category comprises one or more n rows. Embodiment 5 is the method of embodiment 4, wherein the one or more m rows are one or more even-numbered rows, and wherein the one or more n rows are one or more odd-numbered rows such that the one or more m rows and the one or more n rows are arranged in alternating fashion in the array. Embodiment 6 is the method according to any of embodiments 1 to 5 wherein determining the set of local flat-fielding coefficients comprises filtering noise using a local median filter on each one of the plurality of local spatial units associated with the first spatial category; filtering noise using a local median filter on each one of the plurality of local spatial units associated with the second spatial category; computing an average of adjacent local spatial units in the filtered plurality of local spatial units associated with the first spatial category; and dividing the average by the filtered plurality of local spatial units associated with the second spatial category to generate the set of local flat-fielding coefficients. Embodiment 7 is the method according to any of embodiments 1 to 6, wherein the determining global flat-fielding coefficients comprises multiplying the set of local flat-fielding coefficients with the plurality of background illumination values to compute a plurality of local-bias-corrected background illumination values associated with an observed local illumination bias pattern; applying a global median filter to the plurality of local-bias-corrected background illumination values to generate median filtered values; and using the median filtered values to generate the global flat-fielding coefficients. Embodiment is the method of embodiment 7 wherein using the median filtered values comprises dividing an average of the median filtered values by each individual median filtered value. Embodiment 9 is the method according to any of embodiments 1 to 8, wherein applying the set of local flat-fielding coefficients and the set of global flat-fielding coefficients to the plurality of endpoint illumination values comprises multiplying the endpoint image by the local flat-fielding coefficients to generate local bias-corrected illumination values; calculating a mean of the global flat-fielding coefficients; dividing the global flat-fielding coefficients by the mean to generate a set of first quotients; and dividing the local-bias-corrected illumination values by the set of first quotients by the to generate the plurality of illumination-bias-corrected endpoint illumination values.

Embodiment is the method corresponding to any of embodiments 1 to 9, wherein the background cycle is cycle 15 of the run of the dPCR assay and the endpoint cycle is cycle 40 of the run of the dPCR assay.

Embodiment 10 is an illumination bias correction data processing system within a polymerase chain reaction (PCR) instrument, comprising a memory; and a processor operable to retrieve background image data corresponding to a background image captured after a background cycle of a run of the PCR assay by a bias correction flat-fielding engine, the background image data including a plurality of background illumination values corresponding to each sample partition associated with an array of the at least one array of sample partitions; determine, using the background image data and an observed local bias illumination pattern, a set of local flat-fielding coefficients, wherein a local flat-fielding coefficient is calculated for each sample partition of the array; determine a set global flat-fielding coefficients, wherein a global flat-fielding coefficient is calculated for each sample partition of the array; retrieve endpoint image data corresponding to an endpoint image captured after an endpoint cycle of the run of the PCR assay, the endpoint image data including a plurality of endpoint illumination values corresponding to each sample partition associated with the array; and apply the set of local flat-fielding coefficients and the set of global flat-fielding coefficients to the plurality of endpoint illumination values to obtain a plurality of illumination-bias-corrected endpoint illumination values.

Embodiment 12 is the method of embodiment 11, wherein each background illumination value of the plurality of background illumination values comprises a site summary value summarizing pixel intensity values of pixels of a corresponding one sample partition in the background image; and each endpoint illumination value of the plurality of endpoint illumination values comprises a site summary value summarizing pixel intensity values of pixels of a corresponding one sample partition in the endpoint image. Embodiment 13 is the method according to embodiments 11 or 12, wherein the observed local illumination bias pattern is associated with a plurality of local spatial units exhibiting varied illumination in a repeating pattern from one local spatial unit to another local spatial unit, such that the plurality of local spatial units can be sorted into at least two categories, a first spatial category and a second spatial category, corresponding to different levels of illumination resulting from the local illumination bias pattern. Embodiment 14 is the illumination bias correction data processing system according to any of embodiments 11 to 13, wherein the processor, for determining the set of local flat-fielding coefficients, operable to filtering noise using a local median filter on each one of the plurality of local spatial units associated with the first spatial category; filtering noise using a local median filter on each one of the plurality of local spatial units associated with the second spatial category; computing an average of adjacent local spatial units in the filtered plurality of local spatial units associated with the first spatial category; and dividing the average by the filtered plurality of local spatial units associated with the second spatial category to generate the set of local flat-fielding coefficients. Embodiment 15 is the illumination bias correction data processing system according to any embodiments 11 to 13, wherein the processor, for determining global flat-fielding coefficients, operable to multiplying the set of local flat-fielding coefficients with the plurality of background illumination values to compute a plurality of local-bias-corrected background illumination values associated with an observed local illumination bias pattern; applying a global median filter to the plurality of local-bias-corrected background illumination values to generate median filtered values; and using the median filtered values to generate the global flat-fielding coefficients.

Embodiment 16 is the illumination bias correction data processing system according to any of embodiments 11 to 13, wherein the processor, for generating the plurality of bias-corrected endpoint illumination values, operable to multiplying the endpoint image by the local flat-fielding coefficients to generate local bias-corrected illumination values; calculating a mean of the global flat-fielding coefficients; dividing each of the global flat-fielding coefficients by the mean to generate a set of first quotients; and dividing the local-bias-corrected illumination values by the set of first quotients to generate the plurality of illumination-bias-corrected endpoint illumination values.

Embodiment 17 is a non-transitory computer-readable medium including code for performing a method of non-uniformity correction of illumination bias of data output of from a polymerase chain reaction (PCR) assay conducted on a sample using a PCR instrument and a sample plate, the sample plate comprising at least one array of sample partitions, each array of the at least one array of sample partitions comprises a plurality of local spatial units, each local spatial unit comprises two or more sample partitions, performed by a processor-based bias correction flat-fielding engine, the method comprising retrieving background image data corresponding to a background image captured after a background cycle of a run of the PCR assay by a bias correction flat-fielding engine, the background image data including a plurality of background illumination values corresponding to each sample partition associated with an array of the at least one array of sample partitions; determining, using the background image data and an observed local bias illumination pattern, a set of local flat-fielding coefficients, wherein a local flat-fielding coefficient is calculated for each sample partition of the array; determining a set global flat-fielding coefficients, wherein a global flat-fielding coefficient is calculated for each sample partition of the array; retrieving endpoint image data corresponding to an endpoint image captured after an endpoint cycle of the run of the PCR assay, the endpoint image data including a plurality of endpoint illumination values corresponding to each sample partition associated with the array; and applying the set of local flat-fielding coefficients and the set of global flat-fielding coefficients to the plurality of endpoint illumination values to obtain a plurality of illumination-bias-corrected endpoint illumination values.

Embodiment 18 is the computer-readable medium of embodiment 17, wherein determining the set of local flat-fielding coefficients, comprises filtering noise using a local median filter on each one of the plurality of local spatial units associated with the first spatial category; filtering noise using a local median filter on each one of the plurality of local spatial units associated with the second spatial category; computing an average of adjacent local spatial units in the filtered plurality of local spatial units associated with the first spatial category; and dividing the average by the filtered plurality of local spatial units associated with the second spatial category to generate the set of local flat-fielding coefficients.

Embodiment 19 is the computer-readable medium of embodiment 17, wherein the determining global flat-fielding coefficients, comprises multiplying the set of local flat-fielding coefficients with the plurality of background illumination values to compute a plurality of local-bias-corrected background illumination values associated with an observed local illumination bias pattern; applying a global median filter to the plurality of local-bias-corrected background illumination values to generate median filtered values; and using the median filtered values to generate the global flat-fielding coefficients. Embodiment 20 is the computer-readable medium of embodiment 17, wherein applying the set of local flat-fielding coefficients and the set of global flat-fielding coefficients to the plurality of endpoint illumination values, comprises multiplying the endpoint image by the local flat-fielding coefficients to generate local bias-corrected illumination values; calculating a mean of the global flat-fielding coefficients; dividing each of the global flat-fielding coefficients by the mean to generate a set of first quotients; and dividing the local-bias-corrected illumination values by the set of first quotients to generate the plurality of illumination-bias-corrected endpoint illumination values.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (Saas). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “operable to” perform a task or tasks. In such contexts, the phrase “configured to” and “operable to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware; for example, circuits, memory storing program instructions executable to implement the operation, etc. Reciting that a unit/circuit/component is “operable to” perform one or more tasks is expressly intended not to invoke 35 U.S.C. 112, sixth paragraph, for that unit/circuit/component. Additionally, “operable to” can include generic structure (e.g., generic circuitry) that is manipulated by software and/or firmware (e.g., an FPGA or a general-purpose processor executing software) to operate in manner that is capable of performing the task(s) at issue. “Operable to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the system and method for non-uniform illumination correction to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the system and method for non-uniform illumination correction is not to be limited to the details given herein but may be modified within the scope and equivalents of the appended claims.

1. A method of digital image processing that corrects for illumination bias in data generated from a polymerase chain reaction (PCR) assay conducted on a sample using a PCR instrument and a sample plate, the sample plate comprising at least one array of sample partitions, the method including using one or more computer processors to execute processing comprising:
retrieving background image data corresponding to a background image captured after a background cycle of a run of the PCR assay by a bias correction flat-fielding engine, the background image data including a plurality of background illumination values corresponding to each sample partition associated with an array of the at least one array of sample partitions;
determining, using the background image data and an observed local bias illumination pattern, a set of local flat-fielding coefficients, wherein a local flat-fielding coefficient is calculated for each sample partition of the array;
determining a set global flat-fielding coefficients, wherein a global flat-fielding coefficient is calculated for each sample partition of the array;
retrieving endpoint image data corresponding to an endpoint image captured after an endpoint cycle of the run of the PCR assay, the endpoint image data including a plurality of endpoint illumination values corresponding to each sample partition associated with the array; and
applying the set of local flat-fielding coefficients and the set of global flat-fielding coefficients to the plurality of endpoint illumination values to obtain a plurality of illumination-bias-corrected endpoint illumination values.

2. The method of claim 1 wherein:
each background illumination value of the plurality of background illumination values comprises a site summary value summarizing pixel intensity values of pixels of a corresponding one sample partition in the background image; and
each endpoint illumination value of the plurality of endpoint illumination values comprises a site summary value summarizing pixel intensity values of pixels of a corresponding one sample partition in the endpoint image.

3. The method according to claim 1 wherein the observed local illumination bias pattern is associated with a plurality of local spatial units exhibiting varied illumination in a repeating pattern from one local spatial unit to another local spatial unit, such that the plurality of local spatial units can be sorted into at least two categories, a first spatial category and a second spatial category, corresponding to different levels of illumination resulting from the local illumination bias pattern.

4. The method of claim 3, wherein the plurality of local spatial units is a plurality of rows, and wherein the first spatial category comprises one or more m rows and the second spatial category comprises one or more n rows.

5. The method of claim 4, wherein the one or more m rows are one or more even-numbered rows, and wherein the one or more n rows are one or more odd-numbered rows such that the one or more m rows and the one or more n rows are arranged in alternating fashion in the array.

6. The method according to claim 1 wherein determining the set of local flat-fielding coefficients comprises,
filtering noise using a local median filter on each one of the plurality of local spatial units associated with the first spatial category;
filtering noise using a local median filter on each one of the plurality of local spatial units associated with the second spatial category;
computing an average of adjacent local spatial units in the filtered plurality of local spatial units associated with the first spatial category; and
dividing the average by the filtered plurality of local spatial units associated with the second spatial category to generate the set of local flat-fielding coefficients.

7. The method according to claim 1 wherein the determining global flat-fielding coefficients comprises,
multiplying the set of local flat-fielding coefficients with the plurality of background illumination values to compute a plurality of local-bias-corrected background illumination values associated with an observed local illumination bias pattern;
applying a global median filter to the plurality of local-bias-corrected background illumination values to generate median filtered values; and
using the median filtered values to generate the global flat-fielding coefficients.

8. The method of claim 7 wherein using the median filtered values comprises dividing an average of the median filtered values by each individual median filtered value.

9. The method according to claim 1, wherein applying the set of local flat-fielding coefficients and the set of global flat-fielding coefficients to the plurality of endpoint illumination values comprises,
multiplying the endpoint image by the local flat-fielding coefficients to generate local bias-corrected illumination values;
calculating a mean of the global flat-fielding coefficients;
dividing the global flat-fielding coefficients by the mean to generate a set of first quotients; and
dividing the local-bias-corrected illumination values by the set of first quotients by the to generate the plurality of illumination-bias-corrected endpoint illumination values.

10. The method corresponding to claim 1, wherein the background cycle is cycle 15 of the run of the dPCR assay and the endpoint cycle is cycle 40 of the run of the dPCR assay.

11. An illumination bias correction data processing system within a polymerase chain reaction (PCR) instrument, comprising:
a memory; and
a processor operable to:
retrieve background image data corresponding to a background image captured after a background cycle of a run of the PCR assay by a bias correction flat-fielding engine, the background image data including a plurality of background illumination values corresponding to each sample partition associated with an array of the at least one array of sample partitions;
determine, using the background image data and an observed local bias illumination pattern, a set of local flat-fielding coefficients, wherein a local flat-fielding coefficient is calculated for each sample partition of the array;
determine a set global flat-fielding coefficients, wherein a global flat-fielding coefficient is calculated for each sample partition of the array;
retrieve endpoint image data corresponding to an endpoint image captured after an endpoint cycle of the run of the PCR assay, the endpoint image data including a plurality of endpoint illumination values corresponding to each sample partition associated with the array; and
apply the set of local flat-fielding coefficients and the set of global flat-fielding coefficients to the plurality of endpoint illumination values to obtain a plurality of illumination-bias-corrected endpoint illumination values.

12. The method of claim 11, wherein:
each background illumination value of the plurality of background illumination values comprises a site summary value summarizing pixel intensity values of pixels of a corresponding one sample partition in the background image; and
each endpoint illumination value of the plurality of endpoint illumination values comprises a site summary value summarizing pixel intensity values of pixels of a corresponding one sample partition in the endpoint image.

13. The method according to claim 11, wherein:
the observed local illumination bias pattern is associated with a plurality of local spatial units exhibiting varied illumination in a repeating pattern from one local spatial unit to another local spatial unit, such that the plurality of local spatial units can be sorted into at least two categories, a first spatial category and a second spatial category, corresponding to different levels of illumination resulting from the local illumination bias pattern.

14. The illumination bias correction data processing system according to claim 11, wherein the processor, for determining the set of local flat-fielding coefficients, operable to:
filtering noise using a local median filter on each one of the plurality of local spatial units associated with the first spatial category;
filtering noise using a local median filter on each one of the plurality of local spatial units associated with the second spatial category;
computing an average of adjacent local spatial units in the filtered plurality of local spatial units associated with the first spatial category; and
dividing the average by the filtered plurality of local spatial units associated with the second spatial category to generate the set of local flat-fielding coefficients.

15. The illumination bias correction data processing system according to claim 11, wherein the processor, for determining global flat-fielding coefficients, operable to:
multiplying the set of local flat-fielding coefficients with the plurality of background illumination values to compute a plurality of local-bias-corrected background illumination values associated with an observed local illumination bias pattern;
applying a global median filter to the plurality of local-bias-corrected background illumination values to generate median filtered values; and
using the median filtered values to generate the global flat-fielding coefficients.

16. The illumination bias correction data processing system according to claim 11, wherein the processor, for generating the plurality of bias-corrected endpoint illumination values, operable to:
multiplying the endpoint image by the local flat-fielding coefficients to generate local bias-corrected illumination values;
calculating a mean of the global flat-fielding coefficients;
dividing each of the global flat-fielding coefficients by the mean to generate a set of first quotients; and
dividing the local-bias-corrected illumination values by the set of first quotients to generate the plurality of illumination-bias-corrected endpoint illumination values.

17. A non-transitory computer-readable medium including code for performing a method of non-uniformity correction of illumination bias of data output of from a polymerase chain reaction (PCR) assay conducted on a sample using a PCR instrument and a sample plate, the sample plate comprising at least one array of sample partitions, each array of the at least one array of sample partitions comprises a plurality of local spatial units, each local spatial unit comprises two or more sample partitions, performed by a processor-based bias correction flat-fielding engine, the method comprising:
retrieving background image data corresponding to a background image captured after a background cycle of a run of the PCR assay by a bias correction flat-fielding engine, the background image data including a plurality of background illumination values corresponding to each sample partition associated with an array of the at least one array of sample partitions;
determining, using the background image data and an observed local bias illumination pattern, a set of local flat-fielding coefficients, wherein a local flat-fielding coefficient is calculated for each sample partition of the array;
determining a set global flat-fielding coefficients, wherein a global flat-fielding coefficient is calculated for each sample partition of the array;
retrieving endpoint image data corresponding to an endpoint image captured after an endpoint cycle of the run of the PCR assay, the endpoint image data including a plurality of endpoint illumination values corresponding to each sample partition associated with the array; and
applying the set of local flat-fielding coefficients and the set of global flat-fielding coefficients to the plurality of endpoint illumination values to obtain a plurality of illumination-bias-corrected endpoint illumination values.

18. The computer-readable medium of claim 17, wherein determining the set of local flat-fielding coefficients, comprises,
filtering noise using a local median filter on each one of the plurality of local spatial units associated with the first spatial category;
filtering noise using a local median filter on each one of the plurality of local spatial units associated with the second spatial category;
computing an average of adjacent local spatial units in the filtered plurality of local spatial units associated with the first spatial category; and
8
dividing the average by the filtered plurality of local spatial units associated with the second spatial category to generate the set of local flat-fielding coefficients.

19. The computer-readable medium of claim 17, wherein the determining global flat-fielding coefficients, comprises,
multiplying the set of local flat-fielding coefficients with the plurality of background illumination values to compute a plurality of local-bias-corrected background illumination values associated with an observed local illumination bias pattern;
applying a global median filter to the plurality of local-bias-corrected background illumination values to generate median filtered values; and
using the median filtered values to generate the global flat-fielding coefficients.

20. The computer-readable medium of claim 17, wherein applying the set of local flat-fielding coefficients and the set of global flat-fielding coefficients to the plurality of endpoint illumination values, comprises,
multiplying the endpoint image by the local flat-fielding coefficients to generate local bias-corrected illumination values;
calculating a mean of the global flat-fielding coefficients;
dividing each of the global flat-fielding coefficients by the mean to generate a set of first quotients; and
dividing the local-bias-corrected illumination values by the set of first quotients to generate the plurality of illumination-bias-corrected endpoint illumination values.
